(19) United States
(12) Patent Application Publication
(10) Pub. No.: US 2010/0075051 A1
(43) Pub. Date: Mar. 25, 2010

(54) METHOD AND APPARATUS FOR A SHIELD BLADE

(76) Inventor: Curtis William Darling, Freeburg, IL (US)

Correspondence Address: Patent Docket Department;Armstrong Teasdale LLP, One Metropolitan Square, Suite 2600, St. Louis, MO, 63102-2740, US

(21) Appl. No.: 12/566,447

(22) Filed: Sep. 24, 2009

Related U.S. Application Data
(60) Provisional application No. 61/099,745, filed on Sep. 24, 2008.

(51) Int. Cl. B05D 1/32; B05C 11/00

(52) U.S. Cl. 427/282; 118/504

(57) ABSTRACT

A method and apparatus for coating a surface is provided. The apparatus includes a shield. The shield includes a substantially planar body including a thickness, a length, and a width. The body further includes a first edge matingly shaped complementary to a boundary between an area of an object to be coated and an area of the object to be protected from being coated, and a first side wall extending outwardly from a second edge of the body, the second edge adjacent the first edge.

### CROSS REFERENCE TO RELATED APPLICATIONS

This application claims the benefit of U.S. Provisional Patent Application No. 61/099,745 filed Sep. 24, 2008, which is hereby incorporated by reference in its entirety.

### BACKGROUND OF THE INVENTION

The field of the invention relates generally to paint shields, and more specifically, to a method and apparatus for shielding surfaces from paint overspray from painting adjacent surfaces.

At least some known types of paint shields facilitate preventing overspray on a building's surface from a spray gun used to apply paint or other coating to an adjacent or nearby surface. Some paint shields include an adjustable blade holder that permits exchanging blades in the holder when the blade is no longer functional. For specific applications paint shield may include specific features such as a paint shield for shielding the edges of carpets while painting the bottoms of adjoining wails that includes a rectangular bridge portion that extends along one portion of the shield attached so the bridge portion does not touch the protected carpet. Moreover, some paint shields include an elongate handle to allow a painter to support the shield while keeping his arms and hands out of the spray pattern or are secured to an adjustable blade holder. Paint shields are also known to include a transverse crease and a longitudinal crease so the shield can be bent to protect areas intersecting at an angle or are formed of a flexible plastic, such as polyethylene, with straight edges of variable lengths for a variety of surfaces. The paint shield may also be formed to conform to an annular wall surface or circular device or may be extended to fit within a window. Paint shields may be made of different materials such as corrugated cardboard which is plastic coated so the paint shield can be washed for re-use.

However, during spray application, the atomized paint or other coating material tends to be swept to the edges of the paint shield and may follow a path around the edge of the paint shield that directs the spray onto the adjacent surface the shield is intended to protect. If the overspray reaches the adjacent surface, touchup painting may be required. To prevent such overspray, less than the full width of the paint shield is used so that the overspray never reaches the edge. Such a solution reduces the effective width of the paint shield and requires more frequent repositioning of the shield during the coating process. Repositioning costs time and slows the work down.

### BRIEF DESCRIPTION OF THE INVENTION

In one embodiment, a shield includes a substantially planar body including a thickness, a length, and a width. The body further includes a first edge matingly shaped complementary to a boundary between an area of an object to be coated and an area of the object to be protected from being coated and a first side wall extending outwardly from a second edge of the body, the second edge adjacent the first edge.

In another embodiment, a method of coating a surface includes aligning a first edge of a shield blade with a boundary between a designated portion of the surface to be coated and a non-designated portion of the surface to be shielded from being coated, directing a spray of coating material towards the designated portion of the surface using a spray device, and redirecting an excess amount of the spray away from the non-designated portion of the surface using a sidewall extending away from a surface of the shield blade.

In yet another embodiment, a shield blade includes a body formed of sheet material having a first edge complementary to at least one of a surface and a joint between intersecting surfaces, a first sidewall extending away from a second edge of the body, the second edge adjacent the first edge, and a raised ridge formed along a fold line of the body, the raised ridge configured to stiffen the body.

### BRIEF DESCRIPTION OF THE DRAWINGS

FIGS. 1-6 show exemplary embodiments of the method and apparatus described herein.

FIG. 1 is a perspective of a paint shield blade in accordance with an exemplary embodiment of the present invention;

FIG. 2 is a perspective of a known paint shield blade;

FIG. 3 is a perspective view of the paint shield blade shown in FIG. 1 during a coating operation;

FIG. 4 is a plan view of an exemplary embodiment of a blank of sheet material from which the paint shield blade, shown in FIG. 1, is formed;

FIG. 5 is an end view of the paint shield blade shown in FIG. 1 in accordance with an exemplary embodiment of the present invention; and

FIG. 6 is a view taken along marks 6-6 in FIG. 1 illustrating an end view of the paint shield blade, shown in FIG. 1 in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to the application of a coating to a designated surface in the proximity of non-designated surfaces in industrial, commercial, and residential coating applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

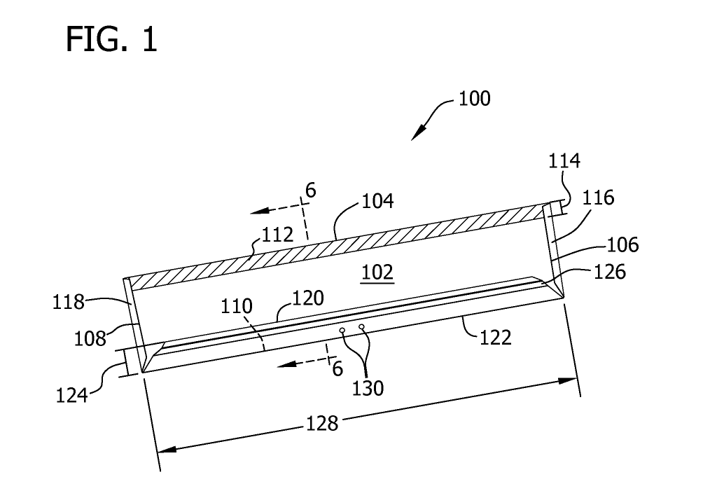

FIG. 1 is a perspective of a paint shield blade 100 in accordance with an exemplary embodiment of the present invention. In the exemplary embodiment, blade 100 comprises a substantially planar surface 102 having a first edge 104, a second edge 106, a third edge 108, and a fourth edge 110. First edge 104 is substantially straight between edges 106 and 108. In various embodiments, edge 104 is coated with surface coating 112 on both sides of blade 100 adjacent to blade edge 104 and extending from edge 104 towards edge 110 a distance 114.

Second edge 16 includes a folded over wing 116 extending at a predetermined angle away from surface 102. In the exemplary embodiment, wing 116 extends for the entire length of edge 106. In an alternative embodiment, wing 116 extends only partially along edge 106.

Third edge 108 also includes a folded over wing 118 extending at a predetermined angle away from surface 102. In the exemplary embodiment, wing 118 extends for the entire length of edge 108. In an alternative embodiment, wing 118 extends only partially along edge 108.

The angle at which wings 116 and 118 extend away from surface 102 may be substantially equal or may be different angels depending on for example, an application in which blade 100 is used or a user preference. The angles between wings 116 and 118 and surface 102 may also be manually adjustable to improve performance of blade 100 with various combinations of coating atomization and spray pressure.

Fourth edge 110 includes a fold over section 120. Fold-over section 120 is folded over surface 102. In the exemplary embodiment, a fold line 122 along edge 110 provides a fold over section 120 of a predetermined width 124. Width 124 is selectable to permit ease of handling of blade 100 using various size and configurations of blade holders (not shown in FIG. 1). In one embodiment, width 124 equals approximately three inches in width. In various embodiments width 124 may be thicker or narrower than three inches. Fold over section 120 includes an raised ridge 126 along a longitudinal length 128 of blade 100. Raised ridge 126 facilitates supporting fold over section 120 against surface 102 and contributes to the rigidity of blade 100. A blade attachment structure 130 is used to couple blade 100 to a support member (not shown) for application of blade 100 to a designated surface for protection from over-spray. In the exemplary embodiment, blade attachment structure 130 comprises two bolt holes inserted through fold over section 120 at an approximate mid-point of blade 100 to provide for attachment of blade holder 214. Blade holder 214 typically is of a design permitting the user to exchange easily blade 100 of one kind, for an alternate blade 100 of another shape or size if necessary. Although illustrated as a rectangular shape in FIG. 1, surface 102 may be formed in a shape of any quadrilateral such as but not limited to a parallelogram or a trapezoid. In various other embodiments, surface 102 may be formed in a triangular shape with for example, edge 110 reduced in length such that edges 106 and 108 meet proximate blade attachment structure 130.

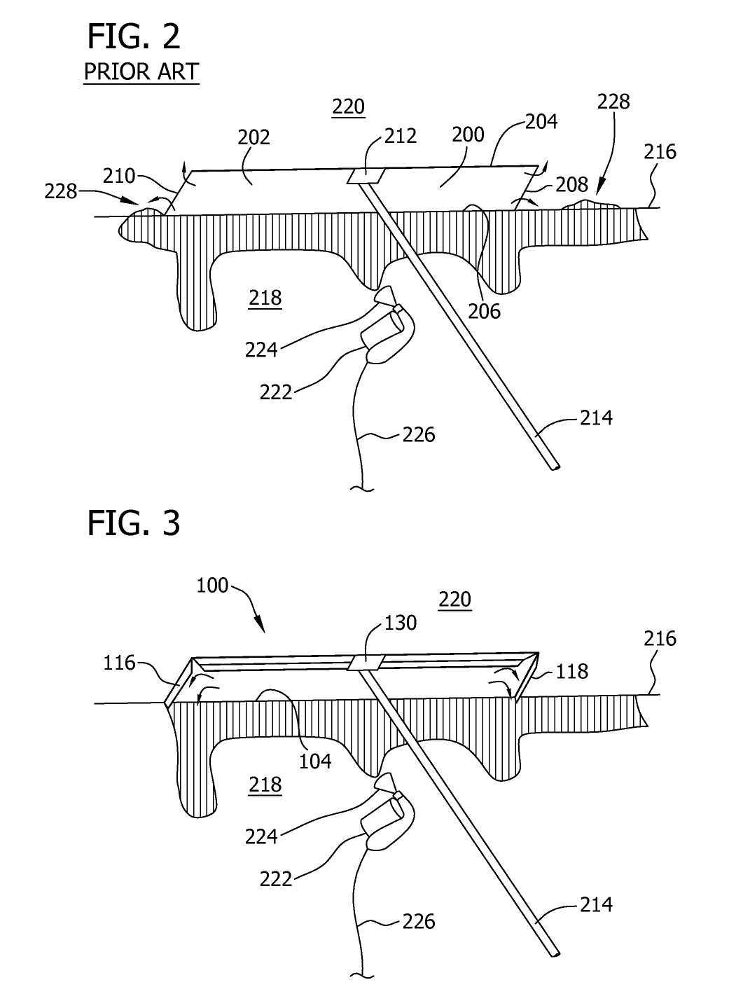

FIG. 2 is a perspective of a known paint shield blade 200. Blade 200 includes a substantially planar surface 202 that extends between opposite side 204 and 206 and between opposite sides 208 and 210. An attachment mechanism 212 is coupled to side 204 and connected to a handle 214.

During operation, when in use, side 206 is aligned with a joint 216 between a designated surface 218 to be coated such as a wall and a non-designated surface 220 that is to be protected from coating such as a ceiling. Blade 200 is manually engaged into joint 216 using handle 214. A spray gun 222 is used to atomize a liquid coating material to form a spray 224. Spray 224 may be formed by entraining the liquid coating material into a gaseous flow through a conduit 226 or may be applied using an airless spray system. Because sides 208 and 210 do not include any barrier, while coating surface 218 near surface 220 and proximate side 208 or 210, a portion of spray 224 may be carried around side 208 or 210 and onto surface 220, creating an overspray area 228 on surface 220. Overspray area 228 must be touched up or otherwise corrected to properly finish the coating operation.

FIG. 3 is a perspective view of paint shield blade 100 (shown in FIG. 1) during a coating operation. In the exemplary embodiment, edge 104 is aligned with joint 216 and positioned into engagement with joint 216 using handle 214. Spray gun 222 is used to direct a flow of atomized or sputtered coating material towards surface 218. As spray 224 is directed towards wings 116 or 118, excess spray is directed away from surface 220 (in this embodiment downward away from the ceiling surface 220). In this way, a greater length of blade 100 may be used during the coating operation permitting fewer periods where spraying is stopped so that blade 100 can be repositioned in a new location.

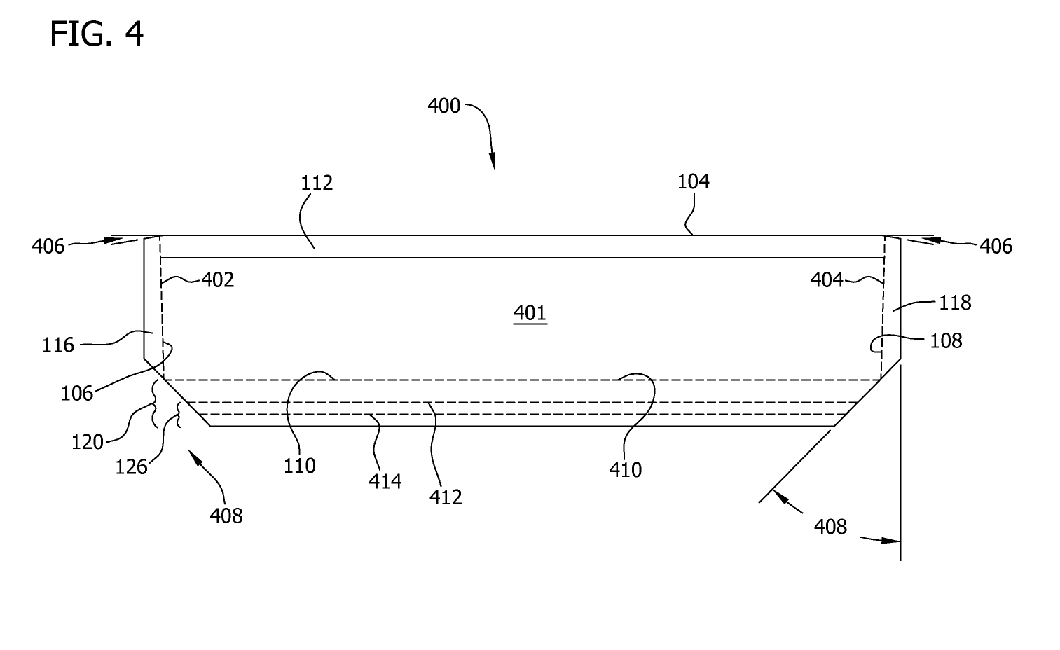

FIG. 4 is a plan view of an exemplary embodiment of a blank 400 of sheet material from which blade 100 is formed. In the exemplary embodiment, blank 400 includes a first surface 401 and is initially a substantially rectangularly shaped aluminum sheet. A plurality of fold lines are shown in dotted lines to show how the component parts of blade 100 are formed. Edge 104 is substantially linear between edges 106 and 108 which are indicated by fold lines 402 and 404, respectively. Wings 116 and 118 are folded up to extend away from surface 401. Wings 116 and 118 are folded to a predetermined and/or selectable angle between wings 116 and 118 and surface 401. In an alternative embodiment, edge 104 is shaped to conform to the joint between two adjacent surfaces such as an arcuate wall meeting a ceiling. Edge 104 is shaped to conform to the curve of the wall. In the exemplary embodiment, a corner area 408 of blank 400 opposite edge 104 are removed to permit pivoting of wings 116 and 118 from surface 401. A portion 406 of wings 116 and 118 are cutaway to facilitate aligning blade 100 with the joint while permitting blade 100 to form an angle of less than ninety degrees with respect to the wall. This configuration permits blade 100 to be used without the surface opposite surface 401 being flush with the ceiling.

A fold line 410 along edge 110 permits forming fold over section 120 and raised ridge 126. Fold lines 412 and 414 permit forming raised ridge 126. In the exemplary embodiment, blank 400 is formed of aluminum of a gauge of suitable strength to provide a rigid exposure with reinforcement by raised ridge 126 along length 128 of blade 100. If blade 100 is formed of aluminum, coating 112 is applied to edge 104 to prevent marks on the wall or on the ceiling surface when encountering the aluminum edge of blade 100. Other materials are suitable as a blade material provided blade end wings 116 and 118 are fabricated and provide protection against over-spray. Use of materials other than aluminum may negate the use of coating 112 over contact edge 104 which provides protection from edge marks on the designated surface.

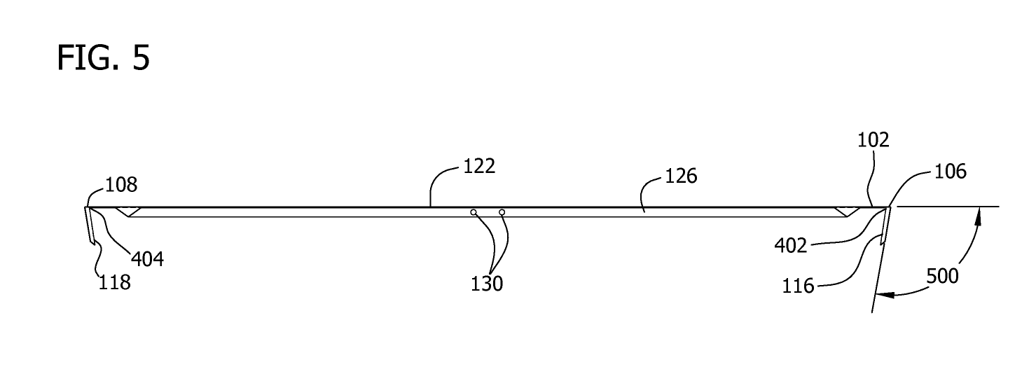

FIG. 5 is an end view of blade 100 in accordance with an exemplary embodiment of the present invention. Wings 116 and 118 are bent along fold lines 402 and 404 respectively to form an angle 500 with respect to surface 102. In the exemplary embodiment, angle 500 is illustrated as being greater than ninety degrees as this has been shown to be an efficient angle for redirecting the excess of spray 124 away from edges 106 and 108.

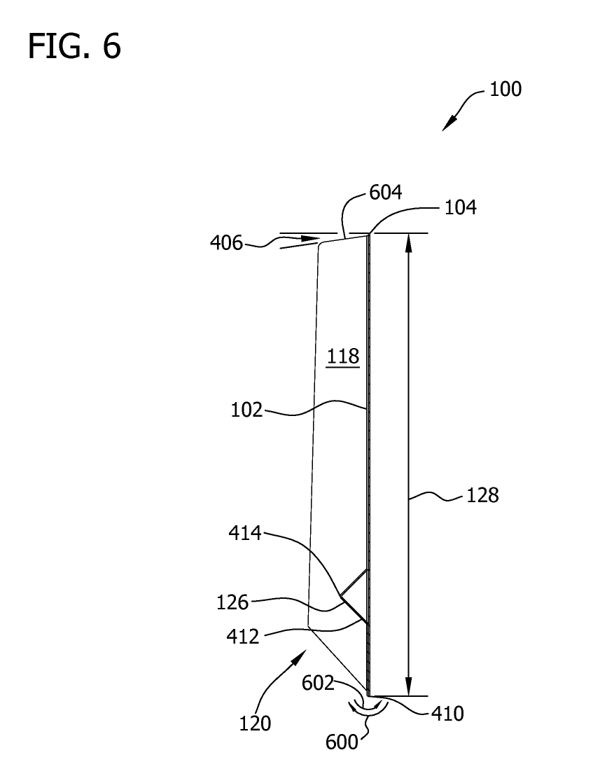

FIG. 6 is a view taken along marks 6-6 in FIG. 1 illustrating an end view of blade 100 in accordance with an exemplary embodiment of the present invention. In the exemplary embodiment, surface 102 extends along length 128 from edge 104 to fold line 410. Fold over section 120 is formed by bending surface 102 around fold line 410 in a clockwise direction 600 as shown in FIG. 6. Fold over section 120 is bent in a counterclockwise direction 602 around fold line 412 and in a clockwise direction 600 around fold line 414 to form raised ridge 126. In the exemplary embodiment, raised ridge 126 is triangularly shaped but, may be formed in other shapes by altering the number of placement of fold lines. Additionally, fold over section 120 and raised ridge 126 may be circularly shaped by bending fold over section 120 around a mandrel (not shown).

In the exemplary embodiment, blade 100 includes upright wings 116 and 118 at each end of surface 102 that provide a contact edge 604 associated with wing 118 and a contact edge similarly orientated and associated with wing 116. The contact edges engage adjoin walls and ceiling surfaces to be protected from overspray. Wings are of a height from surface 102 of approximately one inch height to approximately three inches in height and extend across the width of blade 100.

In one embodiment, blade surface 102 is a rectangle, nine inches in width, forty eight inches in longitudinal expanse and is strengthened by an approximately three inch fold-over section 120 of the width of the aluminum blade surface, which is twelve inches in total surface width that provides rigidity to blade 100. Fold-over section 120 is approximately three inches in width and has a raised ridge 126 running the longitudinal length of fold-over section 120 that supports a positioning of fold-over section 120 to increase the rigidity of fold-over section 120 against surface 102.

The shape of blade 100 in an alternative embodiment can be other than a rectangle with parallel sides, such as of a trapezoidal shape, to cause the protection shield to fit snugly into corners of walls that are not square with one another. During use, a slightly shorter edge of the trapezoid is placed away from the contact with the wall so that the long edge of the trapezoid is in contact with the wall. The resulting acute angle of the protection shield, rather than a right angle, can meet the angle of a wall corner where the sidewall is not perpendicular to the front wall but is of an acute angle in position. Other modified shapes of the protection shield can be used to meet specific requirements of application.

In the exemplary embodiment, blade 100 is aluminum, although other materials, such as other malleable metals or suitable polymer materials such as polyethylene and polyvinylchloride, can be used.

Each wing 116 and 118 are rounded at its upright extreme end to eliminate a sharp pointed end that could otherwise result in inadvertent damage to the wall. The damage would be at the point of contact at the point where placement of the paint shield is against the contacted wall.

Blade 100 being of an improved design permits an improved method for spray painting or spray coating comprising a constant pressure paint spray and a constant pressure spray gun tip. The constant pressure paint spray and constant pressure spray gun tip provides a narrow angle spray resulting in a controlled paint spray easily directed to areas to be spray painted with minimal over spray when used in combination with improved paint shield paint spray protection blade 100. Blade 100 includes side wings or guards at each exterior end serving as “bent wings” to redirect over-spray paint from non-designated surfaces to the designated contact surfaces located below blade 100.

In use, blade 100 is placed over the surface wall or ceiling areas to be shielded from applied paint. The controlled paint spray is directed to a surface area below blade 100 wherein excess coating spray is redirected away from the surface wall or ceiling areas being shielded by wings 116 and 118. The redirected excess spray is assisted by gravity to carry the redirected spray downward away from surface 102 and away from the surface wall or ceiling areas being shielded or is later swept from the surface of the blade to clean the blade of excess coating material.

The above-described embodiments of an improved paint shield and an improved paint spray method provides a cost-effective and reliable means for providing contact surfaces with adjoining wails and ceiling surfaces to be protected from overspray. More specifically, the methods and apparatus described herein includes upright wings at each end of the aluminum shield and a raised ridge stiffener. The upright wings direct a flow of excess spray away from a non-designated surface and the raised ridge stiffener increase the rigidity of the paint shield protection blade. In addition, the above-described methods and systems facilitate improving the power spraying of structure surfaces wherein paint overspray is significantly reduced, less touch-up is required due to less overspray and overall completion time required is significantly reduced. As a result, the method and apparatus described herein facilitate coating surfaces in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A shield comprising:
a substantially planar body comprising a thickness, a length, and a width, the body further comprising
a first edge matingly shaped complementary to a boundary between an area of an object to be coated and an area of the object to be protected from being coated; and
a first side wall extending outwardly from a second edge of the body, said second edge adjacent said first edge.

2. A shield in accordance with claim 1, further comprising a second side wall extending outwardly from a third edge of the body, said third edge adjacent said first edge.

3. A shield in accordance with claim 1, further comprising a fourth edge opposite said first edge, said fourth edge comprising a fold, a folded over portion extending from said fold across said body, and a raised ridge portion extending from said folded-over portion substantially parallel to said fold.

4. A shield in accordance with claim 3, wherein said raised ridge portion comprises a triangular cross-section.

5. A shield in accordance with claim 1, wherein said body comprises a coating extending along said first edge at least partially between said second edge and said third edge.

6. A shield in accordance with claim 1, wherein said first sidewall extends away from said body at an acute angle with respect to said body.

7. A shield in accordance with claim 1, wherein said first sidewall is formed of a portion of said body folded at a fold line substantially coincident with the second edge.

8. A shield in accordance with claim 1, wherein at least one of said body and said sidewall are formed of a ductile metal.

9. A shield in accordance with claim 8, wherein at least one of said body and said sidewall are formed of aluminum.

10. A shield in accordance with claim 8, wherein at least one of said body and said sidewall are formed of a polymeric material.

11. A method of coating a surface, said method comprising:
aligning a first edge of a shield blade with a boundary between a designated portion of the surface to be coated and a non-designated portion of the surface to be shielded from being coated;
directing a spray of coating material towards the designated portion of the surface using a spray device; and
redirecting an excess amount of the spray away from the non-designated portion of the surface using a sidewall extending away from a surface of the shield blade.

12. A method in accordance with claim 11, wherein redirecting an excess amount of the spray away from the non-designated portion of the surface using a sidewall comprises redirecting an excess amount of the spray away from the non-designated portion of the surface using a sidewall that extends away from the surface of the shield blade at an angle less than ninety degrees with respect to the surface of the shield blade.

13. A method in accordance with claim 11, wherein aligning a first edge of a shield blade with a boundary between a designated portion and a non-designated portion comprises aligning the first edge with a joint between a wall surface and a ceiling surface.

14. A method in accordance with claim 11, wherein aligning a first edge of a shield blade with a boundary between a designated portion and a non-designated portion comprises aligning the first edge with a joint between an arcuate wall surface and a flat ceiling surface.

15. A method in accordance with claim 11, wherein directing a spray of coating material towards the designated portion of the surface using a spray device comprises directing a spray of coating material towards the designated portion of the surface using a compressed air spray device.

16. A method in accordance with claim 11, wherein directing a spray of coating material towards the designated portion of the surface using a spray device comprises directing a spray of coating material towards the designated portion of the surface using an airless spray device.

17. A shield blade comprising:
a body formed of sheet material having a first edge complementary to at least one of a surface and a joint between intersecting surfaces;
a first sidewall extending away from a second edge of said body, said second edge adjacent said first edge; and
a raised ridge formed along a fold line of the body, said raised ridge configured to stiffen the body.

18. A shield blade in accordance with claim 17, further comprising a second sidewall extending away from a third edge of the body towards the same side of the body as the first sidewall.

19. A shield blade in accordance with claim 17, wherein said raised ridge is formed in a folded over portion of said body.

20. A shield blade in accordance with claim 17, wherein at least one of said body, said first sidewall, and said raised ridge is formed of at least one of a metal sheet and a plastic sheet.
